(19) United States
(12) Patent Application Publication
(10) Pub. No.: US 2025/0341730 A1
(43) Pub. Date: Nov. 6, 2025

(54) PASSIVE LIGHT WAVE CONVERSION MODULE

(71) Applicant: SMART Photonics Holding B.V., Eindhoven (NL)

(72) Inventors: Johannes Jacobus Gerardus Maria VAN DER TOL, Eindhoven (NL); Kolsoom MEHRABI, Eindhoven (NL); Weiming YAO, Eindhoven (NL)

(21) Appl. No.: 19/267,354

(22) Filed: Jul. 11, 2025

Related U.S. Application Data
(63) Continuation of application No. PCT/NL2024/050020, filed on Jan. 16, 2024.

(30) Foreign Application Priority Data
Jan. 16, 2023 (NL) 2033968

(51) Int. Cl. G02B 27/28; G02B 6/12; G02B 6/126; G02B 6/14

(52) U.S. Cl. CPC G02B 27/283; G02B 6/126; G02B 6/14; G02B 27/286; G02B 2006/1209; G02B 2006/12116; G02B 2006/1215; G02B 2006/12152

(57) ABSTRACT

A passive light wave conversion module for converting an incoming light wave having an undefined polarization into a light wave having a defined polarization, being one of Transverse Electric, TE, polarization or Transverse Magnetic, TM, polarization, the passive light wave conversion module comprising an optical splitter for splitting incoming light, two 50% input polarization converters for converting power in the incoming polarization for 50%, wherein the input polarization converters are connected to the optical splitter, at least one 50% output polarization converter for converting power in the polarizations for 50%, a bimodal phase shifter for introducing phase shifts between the TE polarization and the TM polarization, wherein the bimodal phase shifter is connected to the two 50% input polarization converters and the least one 50% output polarization converter.

### CROSS REFERENCE TO RELATED APPLICATIONS

This application is a continuation under 35 U.S.C. § 120 of International Application No. PCT/NL2024/050020, filed Jan. 16, 2024 which claims priority to Netherlands Application No. NL2033968, filed Jan. 16, 2023 under 35 U.S.C. § 119 (a). Each of the above-referenced patent applications is incorporated by reference in its entirety.

### TECHNICAL FIELD

The present disclosure is related to the field of photonics and, more specifically, to the field of converting an incoming light wave having an undefined polarization state to a light wave having a defined polarization state.

### BACKGROUND

One of the problems in photonic integrated circuits, PICs, is the handling of polarization. A PIC has a planar geometry, and consequently the light waves behave differently if their polarization is in the plane of the chip, i.e. the “TE”-polarization, then when it is perpendicular to it, i.e. the “TM”-polarization. This causes problems if the chip is intended for processing optical signals with an undefined, even changing, polarization, as are e.g. delivered by optical fibres. The result is that, without further measures, the operation of the chip will become unpredictable.

Traditional solutions to make the PIC polarization independent rely on either the use of special waveguides or special circuit designs. The disadvantage of this is that these solutions imply compromises in the performance of the chips. Another idea is to use polarization diversity, which involves splitting the TE and the TM-polarizations, and then processing them separately. Of course this takes up extra surface space on the chips.

All these solutions furthermore have difficulty with dealing with some polarization related problems in optical communication, such as polarization mode dispersion, PMD, and polarization sensitive detection. In this disclosure another solution is proposed, which does not have the disadvantages of the techniques mentioned, can be used to mitigate PMD and facilitate polarization sensitive detection.

### SUMMARY

It would be advantageous to achieve a passive light wave conversion module for converting an incoming light wave having an undefined polarization into a light wave having a defined polarization, being one of Transverse Electric, TE, polarization or Transverse Magnetic, TM, polarization. It would further be advantageous to obtain a corresponding method and photonic device.

In a first aspect of the present disclosure, there is provided a passive light wave conversion module for converting an incoming light wave having an undefined polarization into a light wave having a defined polarization, being one of Transverse Electric, TE, polarization or Transverse Magnetic, TM, polarization, the passive light wave conversion module comprising:
an optical splitter for splitting incoming light;
two 50% input polarization converters for converting power in the incoming polarization for 50%, wherein the input polarization converters are connected to the optical splitter;
at least one 50% output polarization converter for converting power in the polarizations for 50%
a bimodal phase shifter for introducing phase shifts between the TE polarization and the TM polarization, wherein the bimodal phase shifter is connected to the two 50% input polarization converters and the least one 50% output polarization converter.

The passive light wave conversion module is arranged to, for example, convert a TE polarization to a TE polarization and a TM polarization to a TE polarization. The passive light wave conversion module does not need to know the polarization state of the incoming light, as the output will always be a particular polarization state.

In the below, the passive light wave conversion module is elucidated with respect to a TE output. However, the passive light wave conversion module may also operate such that it provides a TM output.

The required function of the passive light wave conversion module may imply a polarization conversion for the TM-part of the incoming mode to TE, while maintaining the TE-part of the incoming mode as TE.

Since polarization conversion is a reciprocal process, like in all linear, non-magnetic and time independent couplers, this may not be achieved with a simple polarization converter.

Therefore an addition to the polarization converter is needed, which creates a relevant difference between the propagation of the incoming TE and TM-modes.

In an example of one of the proposed solution waveguides, birefringence and dispersion will be used, by adding a bimodal phase shifting section. In this section four different modes may be able to propagate, i.e. TE00, TM00, TE01 and TM01, wherein the second index refers to the in-plane direction of the corresponding chip.

It can be engineered, by setting the width and the length of the conversion module and, more specifically, of the bimodal phase shifter, such that the phase shift between TE00 and TM01 is an odd integer of π, while the phase shift between TM00 and TE01 is an even integer of π.

A combination of TE00 and TM01 can be created with two parallel partial polarization converters, i.e., with 50% conversion, from a TE-mode input, while with a TM-mode input these two conversion modules result in a combination of TM00 and TE01.

In an example, each of the polarization converters are arranged to convert half of the power in the TE polarization into the TM polarization and half of the power in the TM polarization into the TE polarization of the corresponding light wave.

In a further example, each of the polarization converters are arranged to introduce a relative phase shift between the TE polarization and the TM polarization.

In another example, the bimodal phase shifter is arranged to guide four different modes:
a TE00 being the TE polarization created by the two 50% input polarization converters based on an incoming light wave having a TE polarization;
a TM01 being the TM polarization created by the two 50% input polarization converters based on an incoming light wave having a TE polarization;
a TE01 being the TE polarization created by the two 50% input polarization converters based on an incoming light wave having a TM polarization;
a TM00 being the TM polarization created by the two 50% input polarization converters based on an incoming light wave having a TM polarization,
   wherein the bimodal phase shifter is arranged to create a phase shift between TE00 and TM01 of an odd integer of π radians, and to create a phase shift between TE01 and TM00 of an even integer of π radians.

In an example, the passive light wave conversion module comprises two 50% output polarization converters.

In another example, the two 50% input polarization converters are arranged such that the outputted converted light of the two 50% input polarization converters are shifted by π radians.

In an even further example, the passive light wave conversion module comprises two 50% output polarization converters, wherein the two 50% output polarization converters are arranged such that the outputted converted light of the two 50% output polarization converters are shifted by π radians.

In another example, the width and the length of the bimodal phase shifter is amended to accomplish that the phase shift between TE00 and TM01 is an odd integer of π radians, and that the phase shift between TE01 and TM00 is an even integer of π radians.

A mathematical description may be provided using transfer matrices, in which each section of the circuit is represented by a matrix. These operate on vectors whose elements are the complex amplitude of each of the modes involved. 4 amplitudes are needed (for the TE and TM modes in both the upper (first and third) and the lower (second and fourth) polarization converters, and the four modes in the bimodal phase shifting section). The following parts can be distinguished:
a) Input. Here a combination of TE and TM modes, with unknown amplitudes and relative phase, is present. To simplify the description the State of Polarization is normalized such that the TE-mode has amplitude “1” and phase “0”. The input vector can thus be represented as:

$${V}_{i n} = ( \begin{matrix}\begin{matrix}{A}_{TE} \\ 0\end{matrix} \\ {A}_{TM} \\ 0\end{matrix} ) = ( \begin{matrix}1 \\ 0 \\ {ae}^{j φ} \\ 0\end{matrix} ) \qquad ( 1 )$$

Where the first row refers to the TE-mode in the upper branch, the second row to the TE-mode in the lower branch (not present in the input yet), the third row to the TM-mode in the upper branch and the last one to the TM-mode in the lower branch.
b) Splitter. Here the input modes are coupled to an upper and a lower branch. This is described by the following matrix:

$${M}_{split} = \frac{1}{√ 2} ( \begin{matrix}1 & 0 & 0 & 0 \\ 1 & 0 & 0 & 0 \\ 0 & 0 & 1 & 0 \\ 0 & 0 & 1 & 0\end{matrix} ) \qquad ( 2 )$$

The factor

$$\frac{1}{√ 2}$$

conserves the total power, thus rosses are so far neglected.
c) Double 50% polarization converter section. The conversion modules in the two branches are mirror images, with the angled sides facing each other. This implies that they give the same (50%) conversion, but with opposite phase on the converted mode. This operation may be described as:

$${M}_{PC 1} = \frac{1}{√ 2} ( \begin{matrix}1 & 0 & j & 0 \\ 0 & 1 & 0 & - j \\ j & 0 & 1 & 0 \\ 0 & - j & 0 & 1\end{matrix} ) \qquad ( 3 )$$

The “j” values in the matrix are because in these kind of coupling processes an extra 90° phase shift occurs between the converted and original modes.
d) Connection to the bimodal phase shifter. The fields from the double polarization sections build up the modes in the phase shifter section. However, in the phase shifter section we need a different definition of the rows and columns in the matrix. Now the four rows/columns, from first to fourth, may refer respectively to TE00, TE01, TM00 and TM01. Each of these modes may be constructed from a combination of two modes from the PC-section, depending on polarization and phase relations of the latter. The matrix for the connection is then:

$${M}_{C onn 1} = \frac{1}{√ 2} ( \begin{matrix}1 & 1 & 0 & 0 \\ 1 & - 1 & 0 & 0 \\ 0 & 0 & 1 & 1 \\ 0 & 0 & 1 & - 1\end{matrix} ) \qquad ( 4 )$$

e) The bimodal phase section. Here the phase shift between TE00 and TM01 (π) and the phase shift between TM00 and TE01 (2π) is created. The matrix for this is:

$${M}_{Bimod} = ( \begin{matrix}1 & 0 & 0 & 0 \\ 0 & 1 & 0 & 0 \\ 0 & 0 & 1 & 0 \\ 0 & 0 & 0 & - 1\end{matrix} ) \qquad ( 5 )$$

f) Connection to the second PC-section. This is the inverse operation of that described under d). The matrix is therefore the same:

$${M}_{Conn 2} = {M}_{Conn 1} \qquad ( 6 )$$

g) The second double 50% polarization converter section. This is identical to the first one, so:

$${M}_{PC 2} = {M}_{PC 1} \qquad ( 7 )$$

The total operation of the circuit is now described as the multiplication of all these matrices:

$${V}_{out} = {M}_{PC 2} {M}_{Conn 2} {M}_{Bimod} {M}_{Conn 1} {M}_{PC 1} {M}_{split} {V}_{i n} \qquad ( 8 )$$

Evaluating this with the matrices given above leads to:

$${V}_{out} = \frac{1}{4 √ 2} ( \begin{matrix}4 + 4 {jae}^{j φ} \\ 4 - 4 {jae}^{j φ} \\ 0 \\ 0\end{matrix} ) \qquad ( 9 )$$

Which means that the output contains only TE-light in the 2 output ports.

In a second aspect of the present disclosure, there is provided a method for converting an incoming light wave having an undefined polarization into a light wave having a defined polarization, being one of Transverse Electric, TE, polarization or Transverse Magnetic, TM, polarization, the method using a passive light wave conversion module in accordance with any of the previous examples, wherein the method comprises the steps of:
splitting, by the optical splitter, incoming light;
converting, by the two 50% input polarization converters, power in the incoming polarization for 50%;
converting, by the at least one 50% output polarization converter, power in the polarizations for 50%;
introducing, by the bimodal phase shifter, phase shifts between the TE polarization and the TM polarization.

It is noted that the same advantages as explained with respect to the first aspect, being the passive light wave conversion module, are applicable to the second aspect, being the method of operating such a passive light wave conversion module.

In an example, the method comprises the step of:
introducing, by each of the polarization converter, a relative phase shift between the TE polarization and the TM polarization.

In a further example, the method comprises the steps of:
guiding, by the bimodal phase shifter, a TE00 being the TE polarization created by the two 50% input polarization converters based on an incoming light wave having a TE polarization;
guiding, by the bimodal phase shifter, a TM01 being the TM polarization created by the two 50% input polarization converters based on an incoming light wave having a TE polarization;
guiding, by the bimodal phase shifter, a TE01 being the TE polarization created by the two 50% input polarization converters based on an incoming light wave having a TM polarization;
guiding, by the bimodal phase shifter, a TM00 being the TM polarization created by the two 50% input polarization converters based on an incoming light wave having a TM polarization, such that a phase shift between TE00 and TM01 of an odd integer of a radians and a phase shift between TE01 and TM00 of an even integer of π radians is created.

In another example, the step of converting, by the two 50% input polarization converters, power in the incoming polarization for 50% comprises:
shifting the outputted converted light of the two 50% input polarization converters by π radians.

In yet another example, the passive light wave conversion module comprises two 50% output polarization converters, wherein the step of converting, by the at least one 50% output polarization converter, power in the polarizations for 50%, comprises:
shifting the outputted converted light of the two 50% output polarization converters by π radians.

In a further example, a width and a length of the bimodal phase shifter is amended to accomplish that the phase shift between TE00 and TM01 is an odd integer of π radians, and that the phase shift between TE01 and TM00 is an even integer of π radians.

In a third aspect of the present disclosure, there is provided an optical device comprising a passive light wave conversion module in accordance with any of the examples as provided above.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE DRAWINGS

FIG. 1 discloses an example of a passive polarization converter.

FIG. 2 discloses a TE mode fraction in the polarization of a guided mode as a function of the waveguide width.

FIG. 3 discloses an effective index of the guided mode as a function of waveguide widths.

FIG. 4 discloses an example of a passive light wave conversion module in accordance with the present disclosure.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the manner in which the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein.

As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

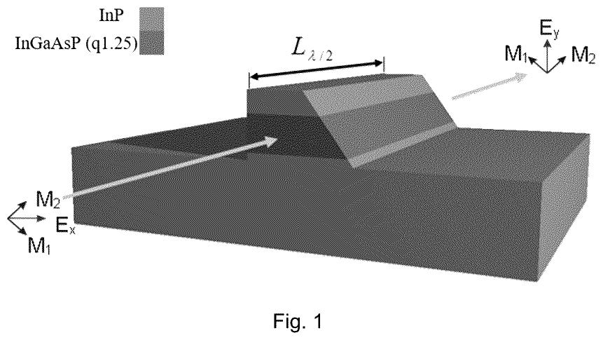

FIG. 1 discloses an example of a passive polarization converter.

A polarization converter design is discussed here below.

The polarization converter may consist of a special asymmetrically shaped waveguide, with one side wall tilted and forming an angle with the chip surface. The cross section of the conversion module is depicted in FIG. 1. The result of this is that the modes in the waveguide become tilted.

With the correct width of the conversion module waveguide the shown tilt is π/4 radians. Placing this waveguide between normal straight side wall waveguides results in an incoming polarized mode (e.g., TE) exciting both of the tilted modes with the same fraction. After propagation through the angled waveguide the accumulated phase difference between the tilted modes determines the reconstruction in the output waveguide.

This results in an integrated version of a retardation plate. The fraction of TE and TM excited modes directly depends on the waveguide widths and the angle of the tilted sidewall. To have the same height as the generic platform based waveguides the thickness of top-cladding is set to 1.5 μm.

The sidewall angle may be equal to 54 degree because of the crystal plane that acts as a stopping plane during wet etching. So, to find the 50/50 excitation of TE and TM modes the waveguide width is swept.

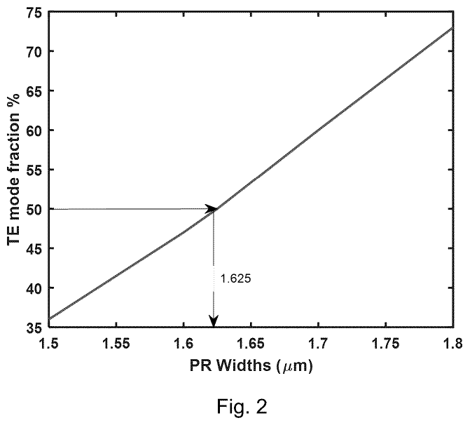

The results are shown in FIG. 2. As is shown with a width of 1.625 μm, the TE fraction is 50%. This means the tilted mode angle is π/4 radians. So, based on equation (10) above, a full polarization conversion length could be 132.1 μm.

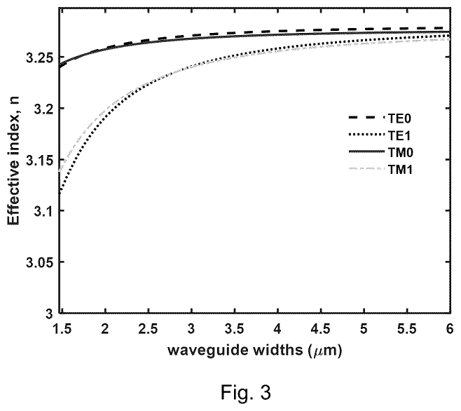

FIG. 3 shows the propagation with TE mode injection through the conversion module. As is depicted the TE mode is converted to TM mode completely. Based on these simulations, the mode conversion efficiency is 99%.

A bimodal phase section is discussed here below.

Eigen mode solver is done to calculate the effective indices of different modes as a function of the MMI widths. As discussed above, for the operation of device, the odd integer of π between the TE0 and TM1 modes and even integer of π between TM0 and TE1 modes are desirable. Any fraction which convince this rule, can be used. In this example design, the widths of the MMI section are chosen such that the results in 3π phase difference between TE0 and TM1, and 2π phase difference between TM0 and TE1.

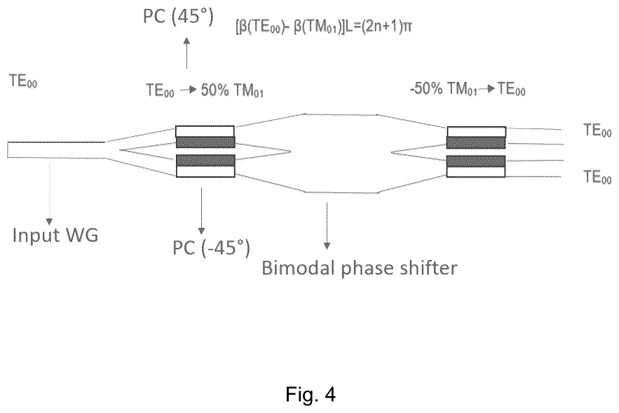

FIG. 4 discloses an example of a passive light wave conversion module in accordance with the present disclosure.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology.

It will be apparent, however, to one skilled in the art that embodiments of the disclosed technology may be practiced without some of these specific details. Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

The following clauses relate to further examples.

Clause 1. A passive light wave conversion module for converting an incoming light wave having an undefined polarization into two light waves having defined polarization, being one of Transverse Electric, TE, polarization or Transverse Magnetic, TM, polarization, the passive light wave conversion module comprising:
an optical splitter for splitting incoming light;
two 50% input polarization converters for converting power in the incoming polarization for 50%, wherein the input polarization converters are connected to the optical splitter;
two 50% output polarization converter for converting power in the polarizations for 50%;
a bimodal phase shifter for introducing phase shifts between the TE polarization and the TM polarization, wherein the bimodal phase shifter is connected to the two 50% input polarization converters and the least one 50% output polarization converter.

Clause 2. A passive light wave conversion module in accordance with clause 1, wherein each of the polarization converters are arranged to convert half of the power in the TE polarization into the TM polarization and half of the power in the TM polarization into the TE polarization of the corresponding light wave.

Clause 3. A passive light wave conversion module in accordance with any of the previous clauses, wherein each of the polarization converters are arranged to introduce a relative phase shift between the TE polarization and the TM polarization.

Clause 4. A passive light wave conversion module in accordance with any of the previous clauses, wherein the bimodal phase shifter is arranged to guide four different modes:
a TE00 being the TE polarization created by the two 50% input polarization converters based on an incoming light wave having a TE polarization;
a TM01 being the TM polarization created by the two 50% input polarization converters based on an incoming light wave having a TE polarization;
a TE01 being the TE polarization created by the two 50% input polarization converters based on an incoming light wave having a TM polarization;
a TM00 being the TM polarization created by the two 50% input polarization converters based on an incoming light wave having a TM polarization,
   wherein the bimodal phase shifter is arranged to create a phase shift between TE00 and TM01 of an odd integer of π radians, and to create a phase shift between TE01 and TM00 of an even integer of π radians.

Clause 5. A passive light wave conversion module in accordance with any of the previous clauses, wherein the bimodal phase shifter is arranged to guide four different modes:
a TE00 being the TE polarization created by the two 50% input polarization converters based on an incoming light wave having a TE polarization;
a TM01 being the TM polarization created by the two 50% input polarization converters based on an incoming light wave having a TE polarization;
a TE01 being the TE polarization created by the two 50% input polarization converters based on an incoming light wave having a TM polarization;
a TM00 being the TM polarization created by the two 50% input polarization converters based on an incoming light wave having a TM polarization,
   wherein the bimodal phase shifter is arranged to create a phase shift between TE00 and TM01 of an even integer of π radians, and to create a phase shift between TE01 and TM00 of an odd integer of π radians.

Clause 6. A passive light wave conversion module in accordance with any of the previous clauses, wherein the two 50% input polarization converters are arranged such that the outputted converted light of the two 50% input polarization converters are shifted by π radians.

Clause 7. A passive light wave conversion module in accordance with clause 6, wherein the two 50% input polarization converters are mirrored to one another, and have a 30 to 45 degree, and a −30 to −45 degree slope output, respectively, such that the corresponding converted signal, by the polarization converters, at the input of the bimodal phase shifter is shifted by π radian.

Clause 8. A passive light wave conversion module in accordance with clause 4, wherein a width and a length of the bimodal phase shifter is amended to accomplish that the phase shift between TE00 and TM01 is an odd integer of a radians, and that the phase shift between TE01 and TM00 is an even integer of π radians.

Clause 9. A passive light wave conversion module in accordance with clause 5, wherein a width and a length of the bimodal phase shifter is amended to accomplish that the phase shift between TE00 and TM01 is an even integer of π radians, and that the phase shift between TE01 and TM00 is an odd integer of π radians

Clause 10. A method for converting an incoming light wave having an undefined polarization into two light waves having defined polarization, being one of Transverse Electric, TE, polarization or Transverse Magnetic, TM, polarization, the method using a passive light wave conversion module in accordance with any of the previous clauses, wherein the method comprises the steps of:
splitting, by the optical splitter, incoming light;
converting, by the two 50% input polarization converters, power in the incoming polarization for 50%;
converting, by the two 50% output polarization converter, power in the polarizations for 50%;
introducing, by the bimodal phase shifter, phase shifts between the TE polarization and the TM polarization.

Clause 11. A method in accordance with clause 10, wherein the method comprises the step of:
introducing, by each of the polarization converter, a relative phase shift between the TE polarization and the TM polarization.

Clause 12. A method in accordance with any of the clauses 9-10, wherein the method comprises the steps of:
guiding, by the bimodal phase shifter, a TE00 being the TE polarization created by the two 50% input polarization converters based on an incoming light wave having a TE polarization;
guiding, by the bimodal phase shifter, a TM01 being the TM polarization created by the two 50% input polarization converters based on an incoming light wave having a TE polarization;
guiding, by the bimodal phase shifter, a TE01 being the TE polarization created by the two 50% input polarization converters based on an incoming light wave having a TM polarization;
guiding, by the bimodal phase shifter, a TM00 being the TM polarization created by the two 50% input polarization converters based on an incoming light wave having a TM polarization, such that a phase shift between TE00 and TM01 of an odd integer of a radians and a phase shift between TE01 and TM00 of an even integer of a radians is created.

Clause 13. A method in accordance with any of the clauses 9-10, wherein the method comprises the steps of:
guiding, by the bimodal phase shifter, a TE00 being the TE polarization created by the two 50% input polarization converters based on an incoming light wave having a TE polarization;
guiding, by the bimodal phase shifter, a TM01 being the TM polarization created by the two 50% input polarization converters based on an incoming light wave having a TE polarization;
guiding, by the bimodal phase shifter, a TE01 being the TE polarization created by the two 50% input polarization converters based on an incoming light wave having a TM polarization;
guiding, by the bimodal phase shifter, a TM00 being the TM polarization created by the two 50% input polarization converters based on an incoming light wave having a TM polarization,
such that a phase shift between TE00 and TM01 of an even integer of a radians and a phase shift between TE01 and TM00 of an odd integer of π radians is created.

Clause 14. A method in accordance with any of the clauses 10-13, wherein the step of converting, by the two 50% input polarization converters, power in the incoming polarization for 50% comprises:
shifting the outputted converted light of the two 50% input polarization converters by π radians.

Clause 15. A method in accordance with any of the clauses 10-14, wherein the step of converting, by the at least one 50% output polarization converter, power in the polarizations for 50%, comprises:
shifting the outputted converted light of the two 50% output polarization converters by π radians.

Cause 16. A method in accordance with clause 12, wherein a width and a length of the bimodal phase shifter is amended to accomplish that the phase shift between TE00 and TM01 is an odd integer of π radians, and that the phase shift between TE01 and TM00 is an even integer of π radians.

Clause 17. A method in accordance with clause 13, wherein a width and a length of the bimodal phase shifter is amended to accomplish that the phase shift between TE00 and TM01 is an even integer of π radians, and that the phase shift between TE01 and TM00 is an odd integer of π radians.

Clause 18. An optical device comprising a passive light wave conversion module in accordance with any of the clauses 1-9.

What is claimed is:

1. A passive light wave conversion module for converting an incoming light having an undefined polarization into two light waves having defined polarization, being one of transverse electric polarization or transverse magnetic polarization, the passive light wave conversion module comprising:
an optical splitter for splitting the incoming light;
two 50% input polarization converters for converting power in an incoming polarization for 50%, the input polarization converters optically connected to the optical splitter;
two 50% output polarization converters for converting power in polarizations for 50%;
a bimodal phase shifter for introducing phase shifts between a transverse electric polarization and a transverse magnetic polarization, the bimodal phase shifter optically connected to the two 50% input polarization converters and the 50% output polarization converters.

2. The passive light wave conversion module of claim 1, wherein each of the polarization converters are arranged to convert half of the power in the transverse electric polarization into the transverse magnetic polarization and half of the power in the transverse magnetic polarization into the transverse electric polarization of the corresponding light wave.

3. The passive light wave conversion module of claim 1, wherein each of the polarization converters are arranged to introduce a relative phase shift between the transverse electric polarization and the transverse magnetic polarization.

4. The passive light wave conversion module of claim 1, wherein the bimodal phase shifter is arranged to guide four different modes:
a TE₀₀ being the transverse electric polarization created by the two 50% input polarization converters based on an incoming light wave having a transverse electric polarization;
a TM₀₁ being the transverse magnetic polarization created by the two 50% input polarization converters based on an incoming light wave having a transverse electric polarization;
a TE₀₁ being the transverse electric polarization created by the two 50% input polarization converters based on an incoming light wave having a TM polarization; and
a TM₀₀ being the transverse magnetic polarization created by the two 50% input polarization converters based on an incoming light wave having a transverse magnetic polarization,
wherein the bimodal phase shifter is arranged to create a phase shift between TE₀₀ and TM₀₁ of an odd integer of π radians, and to create a phase shift between TE₀₁ and TM₀₀ of an even integer of π radians.

5. The passive light wave conversion module of claim 1, wherein the bimodal phase shifter is arranged to guide four different modes:
a TE₀₀ being the transverse electric polarization created by the two 50% input polarization converters based on an incoming light wave having a transverse electric polarization;
a TM₀₁ being the transverse magnetic polarization created by the two 50% input polarization converters based on an incoming light wave having a transverse electric polarization;
a TE₀₁ being the transverse electric polarization created by the two 50% input polarization converters based on an incoming light wave having a transverse magnetic polarization; and
a TM₀₀ being the transverse magnetic polarization created by the two 50% input polarization converters based on an incoming light wave having a transverse magnetic polarization,
wherein the bimodal phase shifter is arranged to create a phase shift between TE₀₀ and TM₀₁ of an even integer of π radians, and to create a phase shift between TE₀₁ and TM₀₀ of an odd integer of π radians.

6. The passive light wave conversion module of claim 1, wherein the two 50% input polarization converters are arranged such that the outputted converted light of the two 50% input polarization converters are shifted by π radians.

7. The passive light wave conversion module of claim 6, wherein the two 50% input polarization converters are mirrored to one another, and have a 30 to 45 degree, and a −30 to −45 degree slope output, respectively, such that the corresponding converted signal, by the polarization converters, at the input of the bimodal phase shifter is shifted by π radians.

8. The passive light wave conversion module of claim 4, wherein a width and a length of the bimodal phase shifter is amended to accomplish that the phase shift between TE₀₀ and TM₀₁ is an odd integer of π radians, and that the phase shift between TE₀₁ and TM₀₀ is an even integer of π radians.

9. The passive light wave conversion module of claim 5, wherein a width and a length of the bimodal phase shifter is amended to accomplish that the phase shift between TE₀₀ and TM₀₁ is an even integer of π radians, and that the phase shift between TE₀₁ and TM₀₀ is an odd integer of π radians.

10. An optical device comprising a passive light wave conversion module for converting an incoming light wave having an undefined polarization into two light waves having defined polarization, being one of transverse electric polarization or transverse magnetic polarization, the passive light wave conversion module comprising:
an optical splitter for splitting incoming light;
two 50% input polarization converters for converting power in the incoming polarization for 50%, wherein the input polarization converters are connected to the optical splitter;
two 50% output polarization converters for converting power in the polarizations for 50%;
a bimodal phase shifter for introducing phase shifts between the transverse electric polarization and the transverse magnetic polarization, wherein the bimodal phase shifter is connected to the two 50% input polarization converters and the least one 50% output polarization converter.

11. A polarization conversion module for a PIC, comprising:
an optical splitter having a first output and a second output;
a first polarization converter configured to receive light from the first output;
a second polarization converter configured to receive light from the second output;
a bimodal phase shifter configured to receive light from the first polarization converter and the second polarization converter, and for introducing a phase shift between a transverse electric polarization and a transverse magnetic polarization;
a third polarization converter configured to receive light from the bimodal phase shifter; and
a fourth polarization converter configured to receive light from the bimodal phase shifter.

12. The polarization conversion module of claim 11, wherein at least one of:
the first polarization converter;
the second polarization converter;
the third polarization converter; or
the fourth polarization converter,
is for a π radians polarization conversion.

13. The polarization conversion module of claim 11, wherein at least one of:
the first input polarization converter;
the second polarization converter;
the third polarization converter; or
the fourth polarization converter,
comprises an asymmetrically-shaped waveguide.

14. The polarization conversion module of claim 11, wherein the polarization conversion module is on a chip surface, and a side wall of the asymmetrically-shaped waveguide an angle of π/4 radians to the chip surface.

15. The polarization conversion module of claim 11, wherein the polarization conversion module is on a chip surface, and a side wall of the asymmetrically-shaped waveguide an angle of 54 degrees to the chip surface.

16. The polarization conversion module of claim 11, wherein at least one of:
the first input polarization converter;
the second polarization converter;
the third polarization converter; or
the fourth polarization converter,
has a width of 1.624 micrometres and a length of 132.1 micrometres.

17. The polarization conversion module of claim 11, wherein each of the polarization converters is for introducing a relative phase shift between the transverse electric polarization and the transverse magnetic polarization.

18. The polarization conversion module of claim 11, wherein the bimodal phase shifter is configured to guide four modes:
a first mode having a transverse electric polarization, and resulting from light having a transverse electric polarization input into the polarization conversion module;
a second mode having a transverse magnetic polarization, and resulting from light having a transverse electric polarization input into the polarization conversion module;
a third mode having a transverse electric polarization, and resulting from light having a transverse magnetic polarization input into the polarization conversion module; and
a fourth mode having a transverse magnetic polarization, and resulting from light having a transverse magnetic polarization input into the polarization conversion module,
wherein the bimodal phase shifter is arranged to create a phase shift between the first mode and the second mode of an odd integer of π radians, and to create a phase shift between the third mode and the fourth mode of an even integer of π radians.

19. The polarization conversion module of claim 11, wherein the bimodal phase shifter is to guide:
a first mode having a transverse electric polarization, and resulting from light having a transverse electric polarization input into the polarization conversion module;
a second mode having a transverse magnetic polarization, and resulting from light having a transverse electric polarization input into the polarization conversion module;
a third mode having a transverse electric polarization, and resulting from light having a transverse magnetic polarization input into the polarization conversion module; and
a fourth mode having a transverse magnetic polarization, and resulting from light having a transverse magnetic polarization input into the polarization conversion module,
wherein the bimodal phase shifter is arranged to create a phase shift between the first mode and the second mode of an even integer of π radians, and to create a phase shift between the third mode and the fourth mode of an odd integer of π radians.

20. The polarization conversion module of claim 11, wherein the first polarization converter and the second polarization converter are mirrored to one another, and have from a 30 to 45 degree, and a −30 to −45 degree slope output, respectively, such that the corresponding converted signal, by the first polarization converter and the second polarisation converter, at the input of the bimodal phase shifter is shifted by π radians.
